(19) United States
(12) Patent Application Publication
(10) Pub. No.: US 2003/0154126 A1
(43) Pub. Date: Aug. 14, 2003

(54) System and method for identifying and offering advertising over the internet according to a generated recipient profile

(76) Inventors: Narayan L. Gehlot, Sayreville, NJ (US); Victor B. Lawrence, Holmdel, NJ (US)

Correspondence Address: James J. DeCarlo, Stroock & Stroock & Lavan LLP, 180 Maiden Lane, New York, NY, 10038, US

(21) Appl. No.: 10/074,078

(22) Filed: Feb. 11, 2002

(51) Int. Cl. G06F 17/60

(52) U.S. Cl. 705/14

(57) ABSTRACT

The current invention provides that data sent from a source computer to a recipient's computer can be selected in real time according to at least one characteristic of the recipient which can be kept in a profile. Information such as the recipient's position, preferred websites, browsing history, content a visited website, information from a third party, or the recipient's response to a question posed also could be included in the profile, and various ways to obtain this information are disclosed. A pricing method values an advertisement sent over the Internet according to the time the recipient viewed the advertisement, or whether the advertisement resulted in an inquiry or sale. The advertisements can be selected in real-time and displayed with the requested web page.

### FIELD OF THE INVENTION

The present invention is directed generally to the transmission of data from a source's computer to a recipient's computer, and, more particularly, to methods of determining in real-time at least one characteristic of the recipient so that the data sent by the source's computer to the recipient's computer can be selected in accordance with that characteristic.

### BACKGROUND OF THE INVENTION

With the continuing expansion of the Internet the transfer of data between different computers over the Internet is becoming ever more widespread. The term “data” is used broadly and, by way of example, refers to any type of information that can be transmitted over the Internet, such as numbers, text, images, sounds and computer programs. One particular type of data commonly sent over the Internet is advertising. Many websites sell advertising space to advertisers, so that users accessing those websites receive along with the downloaded web pages an embedded advertisement. The manner by which such advertising is included with the downloaded website is generally known.

One known Internet advertising scheme is to send to a person requesting a web site an advertisement supplied by a third party (hereafter “the advertiser”) along with the requested web page. Such advertising can in known fashion take the form of a “frame” or “banner” embedded in the requested web page. The “frame” or “banner” can be arranged near the beginning of the requested web page in a way which does not obscure or obstruct any of the requested page.

U.S. Pat. No. 5,937,392 to Alberts, for a “Banner Advertising Display System and Method with Frequency of Advertisement Control” by Alberts, discusses schemes for displaying ads.

Further, U.S. Pat. No. 5,948,061 to Merriman, et al., entitled “Method of delivery, targeting, and measuring advertising over networks”, discloses an advertising server which transmits to people accessing a website page an advertisement.

U.S. Pat. No. 6,122,658, entitled “Custom localized information in a networked server for display to an end user”, describes in part the use of local advertisement information with an internet delivery system.

Other U.S. patents which relate generally to the distribution of advertising using the Internet include: U.S. Pat. Nos. 6,141,010; 6,128,651; and 5. 5,937,390.

Conventional targeted advertising performs ad targeting on the basis of the advertising channel (channel includes electronic, print and other media). In that scheme, the customers “pre-screen” themselves; only certain customers will be interested in the channel, and only certain types of advertisers would advertise on that channel. For example, a sailboat manufacturer might place print advertisements in a boating magazine, knowing the readers of such magazines are more likely to be customers. Conversely, a seller of children's toys probably would not advertise in that publication. The decision where to advertise is, however, made long in advance of the actual running of the advertisement, and this system suffers from the drawbacks of inefficiently, expense, and inflexibility. These shortcomings are particularly apparent with regard to the Internet, which is highly dynamic in nature.

The state of the art in website advertising is subject to a number of shortcomings. Running static advertisements on a website, such as advertisements for air travel, automobile rental, hotel accommodations, cinema offering and clothing so that all visitors to the website receive that advertising is extremely unfocused and inefficient. Although advertisements may be selected from a static (fixed) pool of different advertisements according to the laws of probability; there is no tailoring of the advertising sent to the viewer by the website to increase the likelihood the viewer will be interested in and spend time considering the advertisement. Additionally, where an advertiser wishes to have advertising expedited on an immediate basis, for example, because the advertiser is having a fire sale or needs to generate cash immediately, it may not be possible to run those advertisements effectively in real-time; the number of viewers and their peak may be random, meaning running the advertisement immediately may not be as effective as waiting to run the ad at a time where more of the desired viewers are likely to be using the Internet and so see the advertisement.

Present Internet advertising schemes are not very efficient, because advertising cost is independent of the success of the advertisement that has been run. Generally, on-line advertisements are priced at a flat rate; all advertisements of a given length cost the same amount (“on-line” refers to advertisements sent over the Internet). In some cases it may be known to vary the cost of the advertisement according to the time that the advertisement is run (if one ad is twice as long as another ad it should cost twice as much). It also is known to price the advertising according to the number of advertisements that have been sent (the fee for sending an advertisement 100 times might be twice the fee for sending that advertisement 50 times, or some volume discount might be offered).

Although a website can in theory collect unique information about a visitor to the website, such as an advertiser's website, by sending the visitor a persistent cookie and using suitable programming to search for that cookie when in the future the visitor returns to the website, privacy legislation, whether on the Federal, state or local level, may limit a website operator's ability to collect such information.

Given the aforementioned limitations of conventional on-line advertising, there is a need for a dynamic and efficient advertising scheme which will enable an advertiser to send advertisements via the Internet only to those persons who have characteristics which make it more likely that they will be receptive to those advertisements.

There is a need for an Internet advertising scheme which operates in real-time to obtain information about a recipient, and which uses that information to select and send to the recipient an advertisement.

There is a need for a scheme which gathers information on visitors to a website without running afoul of privacy legislation.

There also exists a need for a dynamic advertisement scheme which enables a user website to obtain and transmit to recipients real-time advertisements received from advertisers, in contrast to conventional systems, where the advertisements are obtained from a fixed pool and are distributed using a static user profile.

### SUMMARY OF THE INVENTION

The present invention involves a system and method for obtaining information in real-time about a recipient and using that information to select an advertisement to be sent over the Internet to the recipient.

One way in which recipient information can be obtained in real-time is by ascertaining the recipient's actual location using positional information obtained from a device associated with the recipient, selecting an advertisement having a correlation with recipient's location, and sending the selected advertisement to the recipient over the Internet.

Another way to obtain information about a recipient for use in sending an advertisement to the recipient who requests a web page from a web site is by identifying the recipient, generating in real-time on the basis of present data a profile for the recipient, selecting an advertisement having a correlation with the profile, and sending the selected advertisement to the recipient over the Internet. The recipient's profile could be generated using information obtained from the recipient's browser, such as from the browser's list of preferred websites or history file, or from information obtained from the content of at least one website which the recipient has visited. Such information also could be obtained from a third party, or from responses given by the recipient to a question posed. The profile could be generated in part based upon a prior profile.

Still another aspect of this invention involves a system and method for obtaining, in real-time, information about a recipient who requests a web page from a web site. To do this, the web site from which the web page is requested is identified and a profile for the recipient is generated, at that time, as a result of the identification of the web site. The recipient is sent at least one of a number of advertisements based upon the generated profile.

If desired, one or more of these schemes could be combined to obtain information in real-time about a recipient who uses a browser to request a web page over the Internet to select an advertisement to be sent over the Internet to the recipient. This could be accomplished by obtaining information indicating the recipient's location, information from at least one of a list of preferred websites and a history file listing sites previously visited from the user's browser, information from content of at least one website which the recipient has visited, information about the recipient from a third party, information from at least one response given by the recipient to a question posed by a third party, and/or information obtained by identifying a web site from which the web page is requested. That information can then be used to prepare a profile for the recipient, and the advertisement sent to the recipient is chosen by virtue of a correlation with the recipient's profile.

This invention also encompasses a pricing system and method for associating a price with an advertisement sent by a web host computer over the Internet to a recipient. This can be done by measuring how long the recipient viewed the advertisement, determining whether the recipient sent the advertiser an inquiry after receiving the advertisement, and determining whether the recipient at least began to place an order with the advertiser. More particularly, a check can be made to see for how long the recipient allowed the advertising banner window containing the advertisement to remain on the recipient's monitor screen, or whether the recipient closed that advertising banner window immediately. Beginning to place an order means that the recipient has started the process of ordering, for example, by selecting the item of interest, and may even have provided a delivery address, but may not have completed that process. By way of non-limiting example, the recipient might have been prevented from completing the order process because of a break in their connection to the Internet, or some interruption such as a phone call or visit from a friend.

The price for the advertisement is then chosen as a function of these criteria. Still other criteria, such as whether the recipient sent the advertiser multiple inquiries or whether the recipient at least began to place multiple orders, also could be used.

### BRIEF DESCRIPTION OF THE DRAWINGS

FIG. 1 depicts a number of different computers connected via the Internet.

FIG. 2 is a detailed schematic diagram showing components of both client and server computers connected through the Internet;

FIG. 3 is a flowchart illustrating a scheme for obtaining a profile for a recipient which is used to determine what advertisements will be sent to the recipient.

FIG. 4 is a sample of a web page having an embedded banner advertisement.

### DESCRIPTION OF THE PREFERRED EMBODIMENT

The following definitions are provided to illustrate in non-limiting manner the meaning of various terms which are used throughout this application:

Advertiser: a party offering goods or services and who distributes promotional information for the purpose of generating interest in and sales of such goods or services.

Advertisement: a promotional communication between a seller offering goods or services to a prospective purchaser of such services. The term “advertisement” as used herein is employed by way of non-limiting example, and should be understood to encompass all data which could be sent from one party to another, whether commercial or not.

Correlation: refers to a nexus between an attribute of a recipient (infra) and an advertisement such that the recipient may find the advertisement to be of interest.

Profile: information concerning an attribute of a recipient (infra) which can be used to determine whether advertising directed to the recipient is likely to be effective.

Recipient: an entity obtaining information from the Internet or other data network. Also can be referred to as a user or viewer.

Tailored advertising: advertising likely to be of heightened interest to a recipient and which is sent to the recipient on the basis of the recipient's profile.

User: one who requests web page data from a web host; see “recipient”, supra.

Viewer: see “recipient”, supra.

Web host: server computer on which the web pages of a website are stored, and which in response to a request for web page data from a recipient sends such web page data to the recipient.

Unlike conventional advertising schemes, the present invention operates, in real-time, both to ascertain a recipient's immediate area(s) of interest and to select and send the recipient an advertisement on the basis of that interest. By doing so, this invention increases advertising effectiveness by sending advertisements to recipients who are interested in the subject matter being advertised, and decreases advertising expenses by reducing the amount of advertising sent to recipients not even interested in what is offered. This is in contrast to conventional Internet advertising, which is not always targeted to the recipient's interests. A recipient sent an untargeted advertisement of no interest will ignore that advertisement, meaning that the space occupied by the advertisement and the cost of sending the advertisement are effectively wasted.

For an advertisement to be effective it must first be considered by the recipient. By advertising in accordance with this invention an advertiser can improve likelihood that an advertisement will be considered, and, hence, the effectiveness of the advertisements sent to the data recipient, since advertisements are only sent to recipients likely to welcome such advertising.

It is significant that the present invention performs advertisement targeting in real-time. That is, this system evaluates the potential customer as the customer is considering the medium where the advertisement is to be placed, the Internet, and immediately sends the advertisement to the customer over the Internet. This is markedly different from a conventional targeted advertising system, which, as noted above, does not target so much as pre-screen, and which is not able to rapidly change adapt to changes in recipient taste, since the decision as to where an advertisement is to be placed is performed well in advance of the actual advertising, and so is inflexible. Because this invention gathers information about the recipient and uses that information to select, at the time the recipient is using the Internet to obtain information, an advertisement to be returned to the recipient along with that information, it is possible for an advertising program to better target advertisements to recipients. As the targeting decisions are made in real-time, the correlation between the recipient's immediate interests and the advertising sent also can be improved.

The present invention relates to a system for sending advertising data from a website maintained on a host's computer to a recipient's computer (alternatively, advertising data could be stored on the advertiser's computer and, when required, be transmitted over the Internet (or other pathway) to the host's computer). An advertisement can be transmitted along with web page data that is being sent from the host computer to the recipient. In this system an advertisement is only sent to recipient if, based upon the recipient's profile, that recipient has or appears to have an interest creating a nexus with the advertisement. Devices used to send and receive the website and advertising information are discussed in detail below.

This invention obtains or generates pertinent information to prepare a profile for the recipient. Such profile building is performed on the fly, as the user “surfs” the Internet. Because it is possible to estimate the recipient's immediate mindset/needs/desires, the profile is used to determine in real-time which advertisements might appeal to the recipient; a recipient is sent advertisements which have some nexus with at least one of the recipient's interests set out in the profile. Advertising conforms more closely to the user's actual identify, and current, real-time interests, and so advertising costs can be reduced. Another way to view this scheme is that advertisements are only sent to recipients having profiles which indicate that the advertising will be of interest. As explained in detail below, this system removes the pre-biasing that could exist when using a fixed user profile, and avoids the attend wastes of time and advertising expense.

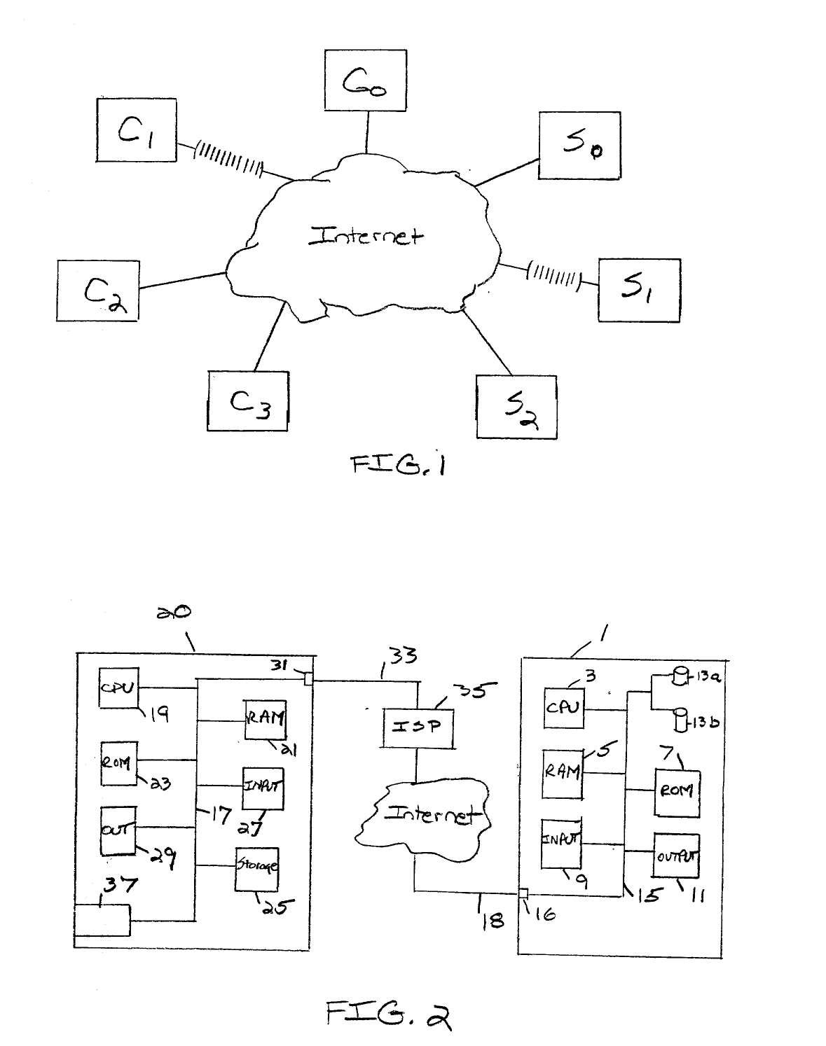

Since the present invention is meant to be used in connection with advertising over the Internet, basic aspects of Internet operation will now be described with reference to FIG. 1. FIG. 1 is a schematic view depicting a number of client computers C0, C1, C2 and C3 and server computers S0, S1 and S2 all connected to the Internet. Client C1 and server S1, it should be noted, are joined to the Internet by wireless connections.

Among the types of data which can be sent between the computers is HTML data (hypertext mark-up language). HTML data can integrate both text and images. By way of non-limiting example, advertisements can take the form of HTML data.

HTML data is typically transferred from a provider to a recipient. When this transfer takes place over a network, the content provider uses one or more server computers each having the appropriate server software to respond to requests for data, and the recipient employs a computer having the appropriate client software to send requests for data and receive and process responses to those requests.

Users typically exchange data, including HTML data, over the Internet using Internet browser software. Examples of browsers include Netscape Navigator® by Netscape Corporation, Internet Explorer® by Microsoft Corporation, and Opera from Opera Software A/S. Since the operation of browser software is generally known, such operation will not be described in detail.

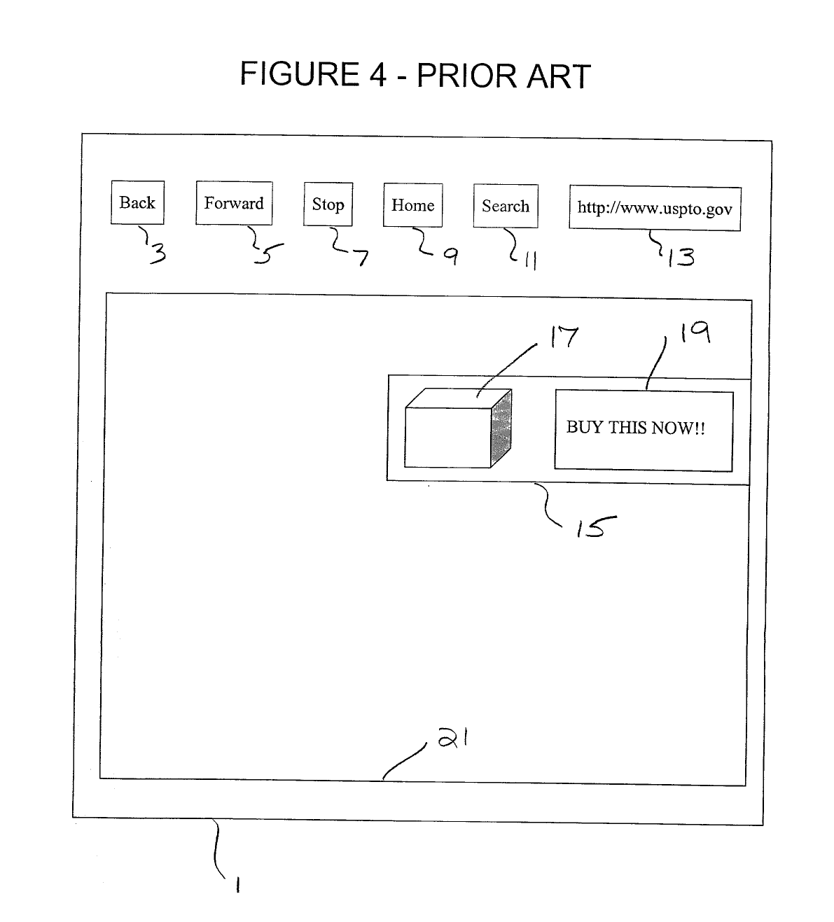

FIG. 4 is a schematic view of a browser window 1 displaying both a web page 21 and an embedded advertisement 15. As depicted in FIG. 4, advertisement 15 can have both image data 17 and text data 19. In known fashion, browser window 1 can include browsing control buttons such as back 3, forward 5, stop 7, home 9 and search 11, as well as a display window 13 which shows the web address of the web page being displayed.

Next, server and client computer equipment suitable for use with this invention will be described.

As depicted in FIG. 2, server 1 has a number of components, each of which will be described hereafter, connected to a bus 15. Bus 15 serves to relay commands and data between various components.

Central processing unit (CPU) 3 serves to control the internal operation of the server 1. Read-only memory (ROM) 7 is a non-volatile memory device which stores programs and data used by the CPU 3 as the server 1 starts up. Random access memory (RAM) 5 is a memory device which contains programs and data used by the CPU 3 during routine operation of server 1. Commands from an operator (not shown) are sent to the server 1 through an input device 9, which could by way of non-limiting example be a keyboard or a pointing device such as a “mouse” or trackball. Server 1 displays information through output 11. Output 11 can, for example, be a video monitor or a printer. Operating program and data files can be stored on an operation drive 13a, and data to be sent out from the server 1 to users can be stored on a content drive 13b. Drives 13a and 13b are preferably magnetic disk drives. The use of different drives 13a and 13b to store the operating programs and data separately from the content data is thought to be preferable because it facilitates the simultaneous reading of such operating information and content data. Moreover, although FIG. 2 depicts the use of two separate drives 13a and 13b, additional drives also could be provided. Alternatively, a single drive could be used.

Various types of data can be stored on server 1 for transmission over the Internet to users. Such data could, by way of non-limiting example, take the form of HTML (hypertext mark-up language) web pages, images, text, programs, audio and video files. The server 1 can therefore function as a data source. The present invention is particularly applicable to the transfer of advertisements, which may include text and image files, as will be described hereafter.

Server 1 has a data port 16 through which the server 1 can exchange data over the Internet with external computers such as client computer 20. By way of non-limiting example, the data port 16 could be a cable modem, telephony modem or network connection. Data port 16 is connected to the Internet by data line 18, which by way of non-limiting example could be a coaxial cable, a telephone line, or an optical fiber, or any type of such connector now known or hereafter developed. Data line 18 also could be a wireless connection such as a satellite link.

In known fashion, server 1 has a unique IP (Internet protocol) address which identifies the server and distinguishes it from all other computers on the Internet.

Data is exchanged between server 1 and the Internet in accordance with pre-established protocols. Requests for data from users and the data sent in response can be exchanged using TCP/IP (Transmission Control Protocol/Internet Protocol), UDP (User Datagram Protocol), or other protocols.

Next, client computer 20 will be described with reference to FIG. 2.

In the same manner as server 1, client computer 20 has a unique IP (Internet protocol) address which identifies the client computer 20 and distinguishes it from all other computers on the Internet. The client computer's address can be either static or dynamic.

Client computer 20 includes a bus 17 through which commands and data flow between the client computer's different components. Central processing unit (CPU) 19 controls internal operation of the client 20. Programs and data used by the CPU 19 during start-up are stored in a read-only memory (ROM) 23. ROM 23 is preferably a non-volatile memory device. A random access memory (RAM) 21 is another memory device and this device contains programs and data that are used by the CPU 3 during routine operation of client 20. Storage device 25, commonly a magnetic disk drive, contains programs and data used by the client 20 during operation. Such programs include client software which enables the client 20 to communicate with the server 1 over the Internet.

Commands are sent to the client 20 by an operator (not shown) using an input device 27, which could by way of non-limiting example be a keyboard or a pointing device such as a “mouse” or trackball. Output 29 is provided to display information from the client 20, and can, for example, be a video monitor or a printer. The information displayed may related to the operating status of the client 20 or be controlled by programs running on the client 20.

A removable storage device 37 can accept, read, and optionally record data on removable media (not shown). By way of non-limiting example, the removable media used by the removable storage device 37 could be a magnetic floppy disk, compact disc (CD) device, a digital video disc (DVD) or a memory card device. Also by way of non-limiting example, the removable storage device 37 can be used to load programs from removable media onto the client 30, or save programs and data from the client 20 onto removable media.

Client 20 can exchange data with external sources such as server 1 via a data port 31. Where data is to be exchanged over the Internet, data port 31, which by way of non-limiting example could be a cable modem, telephony modem or network connection, is connected to a data line 33, which by way of non-limiting example could be a coaxial cable, a telephone line, or an optical fiber. Data line 33 also could be a wireless connection such as a satellite link.

Client 20 exchanges data over the Internet through an Internet Service Provider (“ISP”) 35. When client 20 receives data from an external data source, client 20 functions as a data recipient. Data passes over data line 33 between the ISP 35 and the data port 31. The ISP 35 is itself connected to the Internet in a known manner which need not be discussed herein.

Client 20 could, by way of example only, be a personal computer. Alternatively, the client 20 could be a remote terminal which is connected to a central mainframe computer, a WebTV® unit, a Web-enabled cellular phone, a Web-enabled personal organizer such as a Palm Pilot®, or an Internet appliance, a low-cost device which eliminates certain of a computer's components, such as the hard disk drive.

As shown in FIG. 2, data can be sent from server 1 through data port 16 to data line 18. The data then passes through the Internet 22 to the ISP 35. ISP 35 sends the data to the client 20 over data line 33 to data port 31.

Since data transfer takes place over the Internet, data is transmitted between the server 1 and client 20 using Internet transfer protocols such as transfer control protocol and Internet protocol (TCP/IP). Such protocols are themselves known and need not be described in detail herein.

The expression “activating a link” is used broadly and includes any manner of selecting a link so as to cause a suitable signal to be sent from the user's browser back to the link's source. By way of non-limiting example, this can be done using a mouse, trackball or keyboard, touch-sensitive display screen, or voice-activated software, or other components, in known fashion.

The present invention improves the effectiveness of Internet advertising by tailoring the advertising sent to a recipient (hereafter, “the recipient”) on the basis of what are for the advertiser one or more of the recipient's distinguishing characteristics. Whereas conventional Internet advertising sends the same advertisements to a multitude of different recipients having widely disparate interests, the present invention first obtains and uses a recipient profile to identify in real-time advertising that is likely to interest the recipient (this also can be viewed as using the recipient profile to identify users who are likely to be receptive to a given advertisement). The recipient profile is therefore a collection of data reflecting one or more of the recipient's attributes which can be used to establish a nexus between the recipient and an advertisement.

More specifically, a person using the Internet downloads and displays on their computer a succession of different web pages from one or more websites. This can be done in known fashion by using a browser program either to click hyperlinks appearing on displayed web pages or to input directly the URL of a website which is of interest to the person. More specifically, a person can instruct their Internet browser to send a request to a given website to be sent a page of data. The website responds by sending the person the requested data, which is received by the person's web browser and displayed as the desired page.

Internet advertising can in known fashion take the form of a “frame” or “banner” containing the advertisement and which is embedded in the requested web page. The advertisement can consist of text, image or a mixture of both, and one or more advertisements can be included with a single website. FIG. 4 depicts one example of a web page 21 depicted along with an embedded banner advertisement 15.

Whereas a conventional Internet advertising scheme sends a recipient an effectively random advertisement, the present invention selects and sends the recipient an advertisement the subject matter of which is likely to be of particular interest to the recipient.

Selecting and sending a recipient an Internet advertisement on the basis of particular information about the recipient is, for the purposes of this invention, referred to as “tailored advertising”.

Tailored advertising requires that the provider of the advertisement know something about the recipient relating to the advertising which can be sent. Thus, there can be said to be a nexus between the profile and the advertising. This information gives the provider a basis for determining which advertising to send a given recipient.

The present invention involves a system for tailoring advertising by obtaining profile information in real-time for the recipient. This system includes a number of different schemes for obtaining the recipient's profile.

One way in which a recipient can be profiled is to obtain information about the recipient's geographic location. Another way to obtain a profile for the recipient is to send the recipient a questionnaire and use information obtained from the response to that questionnaire to generate a recipient profile. Additionally, this invention envisions obtaining profile information about a recipient based upon the way in which the recipient “surfs” the Internet (“surf” refers in known manner to the successive viewing of Internet web pages, whether related or unrelated). The recipient's profile also can be obtained from a third-party profile source. Since the information is gathered and processed in real-time, the recipient will receive advertising that is a reflection of the information requested by the recipient using the Internet.

If desired, just one these different profiling techniques could be used, or alternatively, several of these techniques could be used in conjunction.

Detailed examples of different schemes for tailored advertising will now be discussed.

Geographically Tailored Advertising:

Until the advent of the Global Positioning System (“GPS”) system, and the development of devices which include GPS locators, it was not feasible to obtain accurate, detailed location information for individual viewers. This meant an entire scheme of advertising, in which the advertising sent reflects the viewer's unique geographic position, could not exist.

Many common hand-held electronic devices, such as cellular phones, laptop computers, and Internet access devices such as a cellular phone having Internet browsing capability, or a Web appliance, either already have or will soon be available with embedded Global Positioning System (“GPS”) microprocessor chips. Such microprocessors can in known manner determine where on earth they are located using the Global Positioning System. The position of such devices can therefore be readily determined.

In these devices, the GPS system data can be transmitted to the Internet with an HTML tag that the website running advertising can use to dynamically and immediately pinpoint the user's location, provided these devices are connected to the Internet. Such connection to the Internet can, in known manner, take place using wired or wireless signal paths.

In many instances the data recipient's position can be inferred to be the same as that of the device. By way of non-limiting example, where the locating device is a laptop computer or Internet appliance that is actively being used to exchange data over the Internet, advertising can be reliably tailored and sent to the viewer on the basis of the laptop or device's location; the advertising is being sent to the very device which provides the position information. If, however, the recipient's position is determined using a device that is not itself actively exchanging data with the Internet, it is possible that the device is not in the same location as the recipient; for example, the device could have been left home by accident or lent to a friend. In that case, to assume that the recipient and the device are in the same location may be incorrect. This may not be important, in which case the GPS data can be used to establish the recipient's location. If the recipient's position is important, other schemes could be employed to determine whether the indicated position is likely to be the recipient's position. For example, the advertiser could check whether the recipient is using any other GPS-enabled devices that access the Internet. If so, it is more than likely that the recipient is indeed at the indicated location.

It should be understood that in this system GPS information is only used as part of the real-time targeting and selection process by which an Internet advertiser determines what advertisements are sent to a viewer. The viewer's GPS-determined location is not sold. Thus, this arrangement should not run afoul of privacy legislation or private agreements barring the sale of an individual's location which is derived using the GPS system.

By knowing the viewer's location, advertising sent to the viewer can be tailored on the basis of that location, as well as relevant geographic and climatic conditions, and the time. By way of non-limiting example, the viewer could be sent advertising for local clothing merchants offering clothing of the style most appropriate for the immediate local weather, or for nearby restaurants.

Because the viewer's location is identified using the inherent GPS capability of one of the user's devices, it is irrelevant whether the viewer accesses the Internet directly through a direct or a remote connection; the viewer's location can be inferred to be the same as the location of the device. Further, it is irrelevant whether the viewer is accessing the Internet through a firewall.

The term “real-time” is used in the sense of “immediate”, that is, without a perceptible lag. In the present invention, this can involve obtaining profile information for a data recipient, and making a decision and taking action on the basis of that profile information. “Perceptible lag” is loosely defined, and can be satisfied by a system which operates with enough speed so that a data recipient is not cognizant of any delay due to the system's gathering profile information or decisionmaking on the basis of that profile information. In one example given below, “real-time” covers a procedure which questions the recipient before the requested information and associate advertisement are sent—the questions can be considered part of the process by which the recipient requests information.

By way of non-limiting example, this aspect of the present invention may be particularly suited for advertisers selling weather-related products such as clothing, sporting goods, automotive products such as snow tires, or wine. Likewise, local advertisers could use this scheme to target recipients in their immediate locale; i.e., shortly before lunchtime a restaurant could have advertisements sent only to recipients located within a short enough distance that the recipients could travel to the restaurant for to dine.

Dynamically-Generated Tailored Advertising

As previously explained, tailored advertising involves the selection and forwarding in real-time of advertising information to a recipient based at least in part upon one or more characteristics of the recipient. For the purposes of this invention, such characteristic information can, but need not, be contained in a profile. That profile may include one or more relevant facts about the recipient, such as subject matter of interest, place of residence, profession, hobbies and so forth. Also by way of non-limiting example, the profile can be maintained locally on the recipient's computer, say, in the form of a persistent cookie, at a server of the web host which supports the website that sends both web page data and advertising to the recipient, or at the advertiser's own location.

In some instances it will not be possible to obtain stored profile information for the recipient. The necessary profile may be missing, the recipient may have opted not to allow use of such a profile, or there may be a legal bar to the use of stored profile information, or just the storing of profile information. Alternatively, this invention could look also to existing profile information, in which case the selection of advertisements to be sent would take place both on the basis of immediate interests, and prior background information.

This aspect of the invention therefore presumes that no existing profile information, whether geographic, historical, or otherwise, is available for the recipient. Instead, the recipient's current interest, as suggested by the subject matter of the website that is being visited, is used to obtain profile information in real-time.

The present invention can overcome the unavailability of stored recipient profile information by generating a fresh profile of the recipient. This can be done in a number of different ways.

A dynamic real-time recipient profile can be generated based upon the recipient's Internet “surf” history. Profiling can be limited to a given Internet browsing session. By way of non-limiting example, the website which forwards both web pages and advertisements to the recipient can send a suitable ActiveX or Java plug-in program to the recipient's Internet browser which will periodically report back to the website which websites the recipient has visited. This could be done by reading the recipient's browser's history file, the history file being known to contain a record of all the web sites that the recipient has visited during a previous pre-defined period of time, such as a month. Optionally, the information reported back to the website can include the amount of time that the recipient spent at each website.

The profiling program can be set to purge the recipient's profile when the recipient ends the browsing session by closing the browser, or logs out of the computer system which allows Internet access. This may avoid legal prohibitions on the storage of this type of information. Alternatively, the profile could be purged after it reaches a certain size or age, or after a predetermined number of browsing sessions.

Among the benefits of this scheme are that it becomes more accurate with time. After the recipient logs on and begins surfing the Internet the system will start collecting profile information based upon the Internet sites that the recipient visits. The more the recipient surfs, the more information can be gathered and the more detailed the profile becomes.

By focusing on the recipient's present subject of interest this system can avoid the problem of pre-biasing. Pre-biasing may occur when a recipient profile is derived using historical search data or other predetermined data, such as the answers to a questionnaire. Pre-biasing arises when the gathered data, while accurate because it is derived from the recipient's own behavior or answers, nevertheless does not reflect the recipient's present state of mind and immediate interests.

By way of non-limiting example, using historical data in conventional fashion to obtain a recipient's profile may prove inaccurate. For example, advertisers may continuously bombard an Indian national located in the U.S and using the Internet with unwanted advertisements offering cheap telephone calling rates to India, merely because of the recipient's nationality, even thought the Indian national may in fact may be using the Internet to research such subjects of immediate interest as travel, housing, politics, spiritual matters or car purchasing. It can be seen from the subject matter of the advertisements sent to the recipient that undue weight has been given to the recipient's nationality, and insufficient weight has been given to the recipient's present area of interest, which area of interest can be ascertained on the basis of the web site currently of interest to the recipient.

Thus, it is useful to attempt to gauge or estimate what subject matter is on the recipient's mind at the very time the advertisement is being sent. Had such real-time profiling been carried out in the foregoing example, the recipient would have received advertisements relating to travel or automobile sales, subjects deduced to be of present interest because of the recipient's immediate surfing behavior. This scheme is effectively comparable to a predictive filtering method in which current signal conditions are used to predict the incoming signal and to adjust the filter coefficients accordingly. With time the predictive filter becomes more accurate, and the system becomes “smarter” and so will the system which uses this predictive filter.

Combined System

A particularly preferred aspect of this invention involves a system which uses several of the aforementioned profiling schemes together. In this arrangement, a recipient logs on to a host website, and at that time the host of the website takes the following actions to generate a recipient profile. Recipient profile generation takes place in real-time while the recipient receives the downloaded website data, and in conjunction with the use of pre-existing general profile information for the recipient.

Initially, the system seeks to ascertain the recipient's location using GPS technology, in the manner already described. By way of non-limiting example, this will appeal to advertisers selling weather- or place-related products such as clothing, shoes, sporting goods, automobiles and automotive products such as snow tires, and recreational businesses.

According to this system the website forwarding advertisements to the recipient can send the recipient a questionnaire in the form of a web page seeking from the recipient distinguishing information for tailored advertising, such as their name, nationality, gender, and/or age. It should be understood that some jurisdictions may restrict this use of information, in which case other profiling techniques could be employed. For example, if recipient information includes marital status, advertisements for wedding anniversary gifts, flowers, diamonds, or destinations such as Las Vegas could be sent. Here, real-time processing includes the time taken for the recipient to provide the requested information.

Obtaining profile information in this manner may be of particular appeal to manufacturers of toddler's toys, senior care providers, nursing homes, clothiers, ethnic food and beverage suppliers, those doing business in a specialty language such as teachers, ethnic musicians, ethmic entertainment sources and services. College recruiters can use this profiling technique to obtain information for attracting local talents. Phone companies, travel agencies and businesses offering services in connection with birthdays and anniversaries also may benefit from this technique.

The system also can obtain profile information for the recipient according to the websites visited. By way of non-limiting example, a profile based upon surf history could be built using information obtained when the recipient reads a friend's “e-card” (an electronic greeting card), and the information obtained therefrom might be of interest to any of the aforementioned types of advertisers. Similarly, the subject matter of websites that are of interest to the recipient could be used. By way of example, if the system finds the recipient is viewing a website containing automotive information that could be useful for advertising automobile dealers. In like manner, the recipient's profile could be refined as the recipient explores sites relating to possible hobbies or areas of interest such as motorboating, motorcycling, gambling, vacationing, traveling, entertainment, hiking, or collecting. Visits to personal websites such as those of friends or pen pals also might provide useful information. Profile information gathered in this manner might be of interest to advertisers such as stamp sellers, collection agencies, travel agents, gambling casinos, the tourism departments of countries/states/cities, circuses located within a predetermined distance of the recipient, automobile, boat or airplane manufacturers, and sellers of goods.

As a further example of usefulness of surf history profiling, it could be possible to differentiate the attributes of a user from among those of a vast and diverse population for the purposes of distributing entertainment-related advertising where there is a connection between the advertising and the subpopulation of the group into which the recipient falls. For example, the Malaysian population is 50% Malay, 30% Chinese, 10% Indian. If a recipient logs on to Malay newspaper, he can be presumed either to be a Malay or an Indian who knows Malay. In that case, both Malay and Indian ads could be sent. If at any point the recipient shifts websites to a website involving Indian newspaper and films, etc., the recipient can be inferred to be an Indian or someone with Indian interest, in which case the recipient would be targeted with the appropriate ads. If both ads for Malays and Indians were downloaded to the recipient in advance, the Malay ads could then be discarded in real-time.

Another example of using this system to differentiate a user within a vast population profiles the member of a student body having a makeup which is 50% undergraduates, 30% graduates, 10% doctorates and 10% staff. By way of non-limiting example, the user could with some confidence be profiled as a student and not staff if it is noted that the user accesses web pages pertaining to courses offered or registration information. In that case, the recipient could be sent relevant advertisements such as from those providing room and/or board, clothing, study materials, transportation and so forth. Depending upon the precise web pages visited it may be possible to learn even more about the recipient's identity; for instance, if the user accesses websites involving research topics or conducts searches on research areas that are of interest to professors or staff the recipient is likely to be a graduate student. Accordingly, suitable advertisements which may be of interest to the profiled student could be sent.

Surf history profiling also could be used to estimate the recipient's educational and employment credentials when the recipient visits employment websites and looks for specific types of jobs (i.e., doctor, engineer, attorney, secretary). This manner of profiling could be useful for those seeking jobs or to hire employees, since the system could, for a party having the appropriate profile, bring that party to the attention of the potential employer. Similarly, websites specializing in job placement could send to the potential employer copies of resumes in their possession for profiled recipients who appear to possess the qualifications sought by the potential employer. This approach also could be useful for surgery equipment manufacturers, those selling new drugs, medical or engineering hardware or software, new steno products. In national emergencies, news or requests for assistance could be sent to nearby professionals having the proper profiles to obtain their immediate assistance (not all professionals may be registered with the authorities).

As far as determining whether the recipient is a member of the faculty such as a professor, or rather, is a student, it may be possible to obtain that information from the recipient' signature file, for example, if that the user's title is contained therein.

The recipient's level of interest in a website can be gauged by measuring the amount of time the user spends there.

To speed downloading of the advertisements they could be transmitted to the recipient's computer and stored thereon until such time as the advertisements are called up from temporary memory and displayed.

Further Considerations:

Another aspect of this invention is that the advertising companies do not receive information about the identified users. Rather, advertisers receive requests for advertising relating to the user for the period of time that the user is accessing the Internet. Should the user click on the ad to activate it, the user and advertiser could then be sent details about each other.

Moreover, it should be noted that the recipient's profile is generated on the fly, and is discarded when the recipient closes his browser. User identity data is not sent to the advertisers, and so this scheme is believed to avoid conflicts with privacy legislation.

A further benefit to this arrangement is that since profile information is generated locally and on the fly, the system can operate even where the recipient accesses the Internet using a computer system having a firewall that screens and blocks the exporting of user profile information.

By way of further non-limiting example, the initial data used in generating a recipient's profile could be obtained from one or more of the following sources: (1) the list of favorites or bookmarks found on the recipient's Internet browser; (2) the most recent X websites listed on the recipient's browser's Internet history file (X being an integer of value at least 1); (3) information contained in or based upon news, articles or web pages read by the recipient; and (4) information chosen by the recipient on the current web site. Moreover, user profile information could be obtained from third parties, such as parties who gather personal data from Internet users by requesting the users to register and provide personal information and who in exchange have a chance to win a prize. Information also could be obtained from manufacturers who invite customers to register their purchases and ask for relevant profile data.

The following further preferred embodiment of this invention envisions three different possible scenarios arising with regard to a user's profile.

First, the recipient's profile already may exist and be available, in which case the profile can be updated using information from the recipient's browser's Internet history file. In this scenario, the host computer, this being the website which sends the recipient both the requested content and the advertising, has Java applets of the same size for advertising different items. When the host site has obtained sufficient information about the recipient the advertisements are updated with contest and the host will replace advertisements sent to the recipient with advertisements reflecting the recipient's interest. This approach is intended to track what the recipient has in mind as being presently of interest; for example, when a recipient selects an article to read, the advertisements that the recipient receives are obtained in a selection process carried out on the basis of the recipient's profile, the nature of the current article and the nature of a number of previous articles of interest. The advertisements preferably closely reflect what the user has in mind and it is hoped the advertisements sent will reflect the recipient's current intentions and area(s) of interest.

In the second scenario there is no profile for the recipient, although access can be had to the Internet history file on the recipient's browser. Here, a temporary profile reflecting the recipient's likes and dislikes is generated from information contained in the browser's Internet history file. For example, in this embodiment, if the recipient is reading an article, the web host will send a request in real-time to an information collection agency for the recipient's profile. Information collectors can include any site previously frequented by the recipient; i.e., the recipient may in the past have visited CNN and provided information that CNN now would be willing to sell. Other sites such as credit card companies, on-line purchasing agencies or merchants also may have information that they will sell.

In the third scenario there is no profile for the recipient, and the recipient's browser's Internet history file either is not available or is available but access thereto has been denied. Consequently, a fresh recipient profile can be generated. One way to do that is to ask the recipient to answer questions seeking profile data. By way of non-limiting example, it may be possible to increase the response rate by offering the recipient something of perceived value for answering these questions. For instance, a recipient could be told that by answering the questions he will be better served by the web site, and/or the recipient will be enrolled in a drawing for some prize.

Alternatively, information used in generating a profile for the recipient can be collected while the recipient visits a website to obtain information. For example, a recipient who is a basketball fan might visit a site to read an article of interest, and from this the user's profile could be updated in a level of detail ranging from general to highly specific; for example, a user reading a particular article at a sports-related web site might be presumed to have an interest in sports, basketball, the Lakers team, the players Shaquille O'Neal or Michael Jordan. With this information tailored advertising selected in view of the recipient's profile can be sent; advertisements for game tickets and items of sporting paraphernalia of interest such as trading cards for those matching the recipient's profile with regard to factors such as age, gender, and ethnicity/race can be chosen.

As a further example, the user jumps to a site having health-related articles. For this example it is assumed that the user is reading an article on LASIK corrective eye surgery, which uses lasers to improve eyesight. In that case, advertisements from doctors or hospitals offering LASIK surgery services can be transmitted to the recipient's computer for display. If desired, the recipient also could be prompted for further information relating to the subject of interest, such as whether he is using eyeglasses, what is his age, contact address, phone number, are there other members in house (children and souse, parents etc) and would the recipient be interested in LASIK surgery. The recipient's answers to these questions allow a user profile to be developed, although that profile may only be accurate with regard to the particular subject of interest.

The information obtained in this manner can be used in a variety of ways. For example, the information obtained about the recipient's need for glasses could be shared with websites selling eyeglasses. This information also could be shared with contact lens manufacturer and suppliers.

The same recipient could be asked other queries based upon the recipient's indicated interest in a subject such as eyeglasses and leading to other subjects. By way of non-limiting example, the same recipient could be asked if they use glasses just for reading, or also for driving, flying, motorcycle riding or boat piloting. The answers to these questions can be used to further amend and refine the user profile.

If desired, and depending upon the recipient's initial response, the recipient could be asked further questions on subjects of indicated interest. By way of non-limiting example, the user could be prompted for information on boats, cars or airplanes that he owns or rends. The recipient's answers to these questions again would determine the type of advertising that might be of interested. The web host, knowing more about the recipient, could contact advertisers offering products which would appeal to the recipient in real-time and tell the advertisers that the web host has a client with a profile that suggests the recipient would be interested in receiving advertising from those advertisers. The advertiser could then prompt and send the web host an advertisement that could be sent to the recipient either at the present time or in the future when the recipient returns to the web site.

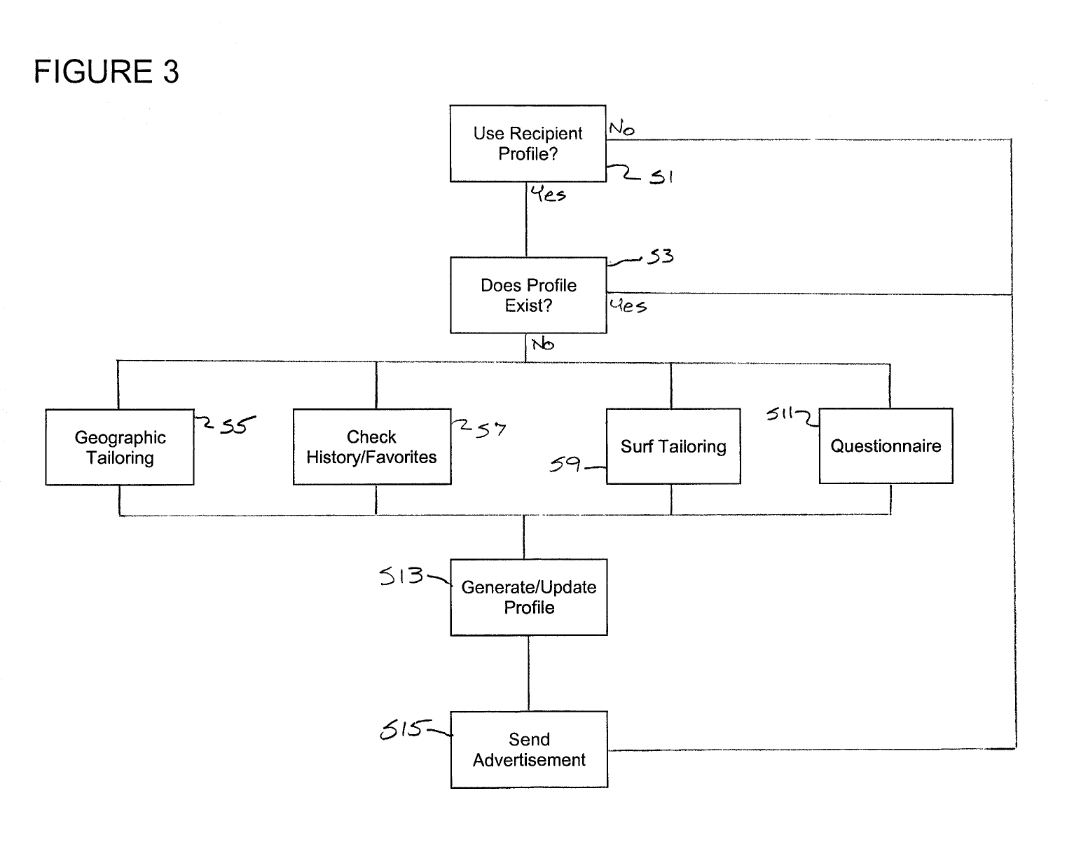

A particularly preferred scheme for tailored advertising will now be discussed with reference to FIG. 3. As depicted therein, this scheme begins in step S1 with a determination as to whether a recipient's profile is to be used for tailored advertising. If the answer is “no”, the process flow advances directly to step S17, and the advertisement is sent.

If in step S1 it is determined that the recipient's profile is to be used, then the process advances to step S3, where a determination is made as to whether the recipient profile already exists and can be used. If the answer is “yes”, the process advances to step S17 and the advertisement is sent on the basis of the existing recipient profile.

If in step S3 it is determined that the recipient's profile either does not exist, exists but is not to be used, or exists but must be updated, then processing advances to one or more of steps S5, S7, S9, S11 and/or S13.

In step S5, the time is checked. By way of non-limiting example, time can refer to the season, date, whether it is day or night, the next meal, or the next holiday. In step S7 geographic tailoring is performed as already discussed. In step S9 the History and/or Favorite files of the recipient's browser can be checked for information used in the recipient's profile, as outlined above. Surf tailoring can be performed in step S11, in the manner already discussed. Step S13 provides for sending a questionnaire to the recipient, the answers to which can be used in preparation of the user profile. If desired, only some of steps S5, S7, S9, S11 and S13 can be performed.

Once the appropriate information has been obtained from one or more of steps S5, S7, S9, S11 and S13, the gathered information is used in step S15 to generate a new recipient profile or update a pre-existing recipient profile.

Then in step S17 an advertisement is sent to the recipient on the basis of the new or updated user profile.

As will be explained in greater detail below in the section entitled “Dynamic Pricing of Advertisements”, a determination is made in step S19 whether the advertisement was successful in provoking a response. If the advertisement was successful, then that success is quantified in step S21, where the amount of time the recipient spent viewing the advertisement before exiting is determined. That information is then used in step S22, where the rates charged to advertisers are set at least in part on the basis of whether those advertisements were successful (unsuccessful ads may cost less than those which are successful).

As an alternative embodiment of this invention, the information obtained in one or more of steps S5, S7, S9, S11 and/or S13 can be used in step S22 to at least partially determine the rates charged to advertisers; by way of non-limiting example, advertising costs could be lowered late at night, where viewership may be reduced. Also by way of example, advertising rates could be raised where the user has in step S13 obtained a great deal of information from the recipient.

Dynamic Pricing of Advertisements

Still another aspect of this invention involves the manner in which advertisements are priced. Unlike conventional advertising, where the advertising cost is selected according to the number of advertisements run, and possibly, the place where and hour that the advertisements are sent, dynamic pricing in accordance with this invention bases the advertisement's price upon the advertisement's effectiveness. By way of non-limiting example, the price charged to the advertiser can be adjusted according to the amount of time that the recipient viewed the advertisement. Moreover, the advertisement's cost can be increased if the advertisement generated sufficient interest to cause the recipient to jump from the downloaded website containing the advertisement to the advertiser's own website. The price charged also can be changed if the advertisement generated interest in the offered subject matter. If the advertisement is particularly successful the recipient may decide to place. have begun to place or actually have placed an order. An advertisement also may have collateral effectiveness if it stimulates the recipient to consider purchasing or actually purchase other goods or services from the advertiser. In the present system, the cost of an advertisement also can be increased if the recipient asks a question about non-advertised subject matter, and can be increased even more if the recipient actually orders that non-advertised subject matter, since such interest shows the advertisement was particularly useful.

By way of still another non-limiting example, an advertiser could arrange with a third-party website that whenever the individual just discussed in the previous paragraph logs onto their web site they should run an identified advertisement of the advertiser's for a predetermined amount of time. The fees paid from the advertiser to the third party could be determined according to the size of the advertisement, the number of times that the advertisement ran, the amount of time that the recipient spent considering the advertisement, or even at a flat rate. The advertising fee also could be determined according to whether the recipient actually purchased something from the advertiser.

These aspects of the invention can be implements in the manner depicted in FIG. 3, and in particular, at steps S19, S21 and S23.

Although the explanation of this invention describes its use in connection with the Internet, this invention is not intended to be limited thereto. The present invention also could be adapted for use over any other known or future developed networks. By way of non-limiting example, this invention could also be used over an Ethernet local area network.

Likewise, although the foregoing explanation of this invention discusses the sending of advertising, this invention is not to be limited thereto. It is envisioned that the concepts taught herein could be applied to the transmission of any type of data over a computer network.

What is claimed is:

1. A system for supplying an Internet advertisement to a recipient who is using the Internet, comprising:
a receiver which accepts a signal from a device associated with the recipient, the signal indicating the location of the device;
a processor that in real-time selects from a plurality of advertisements at least one said advertisement having a correlation with the location of the device; and
an output which sends the selected advertisement to the recipient.

2. A system according to claim 1, wherein the correlation is at least one of a climatic association, a proximity association and a regional association.

3. A system according to claim 1, wherein the device is selected from the group consisting of a personal computer, a remote terminal connected to a central mainframe computer, a WebTV® unit, a Web-enabled cellular phone, a Web-enabled personal organizer and an Internet appliance.

4. A system according to claim 1, wherein signal is obtained from a global positioning system chip contained in the device.

5. A system according to claim 1, wherein the receiver is a web host computer which stores and transmits web page information to the recipient.

6. A system according to claim 5, wherein the output transmits information about the recipient's location from the web host computer to an advertiser's computer and the web host computer receives from the advertiser's computer an advertisement having a correlation with the location of the device, and as a result, the output sends the advertisement to the recipient.

7. A method for supplying an Internet advertisement to a recipient who is using the Internet, comprising the steps of:
receiving an item of positional information from a device associated with the recipient, the item of positional information indicating the location of the device;
selecting in real-time from a plurality of advertisements at least one said advertisement having a correlation with the location of the device; and
sending the selected advertisement to the recipient over the Internet.

8. A method according to claim 7, wherein the step of sending comprises transmitting the advertisement along with a web page that the recipient has requested so that the advertisement is displayed together with the web page.

9. A method according to claim 7, wherein the correlation is at least one of a climatic association, a proximity association and a regional association.

10. A method according to claim 7, wherein the device is selected from the group consisting of a personal computer, a remote terminal connected to a central mainframe computer, a WebTV® unit, a Web-enabled cellular phone, a Web-enabled personal organizer and an Internet appliance.

11. A method according to claim 7, wherein the item of positional information is provided by a global positioning system chip contained in the device.

12. A method according to claim 7, wherein the step of receiving is performed by a web host computer which stores and transmits web page information to the recipient.

13. A method according to claim 12, wherein the advertisements are stored on an advertiser's computer, and further comprising the steps of:
transmitting information about the location to the advertiser's computer from the web host computer to the advertiser's computer;
receiving, at the web host computer, the advertisement having a correlation with the location of the device, from the advertiser's computer as a result of the transmitting; and
sending the advertisement from the web host computer to the recipient.

14. A system for selecting in real-time and sending an Internet advertisement to a recipient who is using the Internet and who requests a web page from a web site, comprising:
a data collector that receives information about the recipient;
a profile generator that uses the information from the data collector to identify the recipient; and, in real-time, to generate a profile for the recipient;
a selector which uses the profile to select from a plurality of advertisements a particular said advertisement that has a correlation with the profile; and
an output which sends the selected advertisement to the recipient.

15. A system according to claim 14, wherein the information used by the profile generator is obtained from a browser used by the recipient.

16. A system according to claim 15, wherein the information used by the profile generator comes from at least one of the browser's list of preferred websites and the browser's history file listing sites previously visited.

17. A system according to claim 14, wherein the information used by the profile generator is obtained from content of at least one website which the recipient has visited.

18. A system according to claim 14, wherein the information used by the profile generator is obtained from a third party.

19. A system according to claim 14, wherein the information used by the profile generator is obtained from at least one response given by the recipient to a question posed.

20. A system according to claim 14, wherein the information used by the profile generator includes a prior profile.

21. A system according to claim 14, wherein the output transmits the advertisement along with the web page that the recipient has requested so that the advertisement is displayed together with the web page.

22. A method for selecting in real-time and sending an advertisement to a recipient who is using the Internet and who, over the Internet, requests a web page from a web site, comprising the steps of:
identifying the recipient;
generating in real-time a profile for the recipient;
selecting from a plurality of advertisements at least one said advertisement having a correlation with the profile; and
sending the selected advertisement to the recipient over the Internet.

23. A method according to claim 22, wherein the recipient requests the web page using a browser and wherein the profile is generated using information obtained from the browser.

24. A method according to claim 23, wherein the information obtained from the browser comes from at least one of the browser's list of preferred websites and the browser's history file listing sites previously visited.

25. A method according to claim 22, wherein the profile is generated using information obtained from content of at least one website which the recipient has visited.

26. A method according to claim 22, wherein the information is obtained from a third party.

27. A method according to claim 22, wherein the information is obtained from at least one response given by the recipient to a question posed.

28. A method according to claim 22, wherein the profile is generated in part based upon a prior profile.

29. A method according to claim 22, wherein the step of sending comprises transmitting the advertisement along with the web page that the recipient has requested so that the advertisement is displayed together with the web page.

30. A system for selecting in real-time and sending an Internet advertisement to a recipient who is using the Internet:
a data collector that identifies a web site from which the recipient has requested a web page;
a profile generator that uses the identified web site, in real-time, to generate a profile for the recipient;
a selector which uses the profile to select from a plurality of advertisements a particular said advertisement that has a correlation with the profile; and
an output which sends the selected advertisement to the recipient.

31. A system according to claim 30, wherein the output sends the advertisement along with the requested web page so that the advertisement is displayed together with the web page.

32. A method for selecting in real-time and sending an Internet advertisement to a recipient who is using the Internet, comprising the steps of:
identifying a web site from which a recipient has requested a web page identifying the web site from which the web page is requested;
generating in real-time a profile for the recipient as a result of the identifying of the web site;
selecting from a plurality of advertisements at least one said advertisement based upon the generated profile; and
sending the selected advertisement to the recipient over the Internet.

33. A method according to claim 32, wherein the step of sending comprises transmitting the advertisement along with the requested web page so that the advertisement is displayed together with the web page.

34. A system for selecting in real-time and sending an Internet advertisement to a recipient who is using the Internet:
a data collector that obtains, for a recipient using a browser to request a web page over the Internet, at least one of a first information indicating a location of the recipient, a second information from at least one of a list of preferred websites and a history file listing sites previously visited of the user's browser, a third information from content of at least one website which the recipient has visited, a fourth information about the recipient from a third party, a fifth information from at least one response given by the recipient to a question posed, and a sixth information identifying a web site from which the web page is requested;
a profile generator that uses at least one of the first information, the second information, the third information, the fourth information, the fifth information, and the sixth information, in real-time, to generate a profile in real-time for the recipient;
a selector which selects from a plurality of advertisements at least one said advertisement having a correlation with the profile; and
an output which sends the selected advertisement to the recipient.

35. A system according to claim 34, wherein the output sends the advertisement along with the requested web page so that the advertisement is displayed together with the web page.

36. A method for selecting in real-time and sending an Internet advertisement to a recipient who is using the Internet, comprising the steps of:
obtaining, for a recipient using a browser to request a web page over the Internet, at least one of a first information indicating a location of the recipient, a second information from at least one of a list of preferred websites and a history file listing sites previously visited of the user's browser, a third information from content of at least one website which the recipient has visited, a fourth information about the recipient from a third party, a fifth information from at least one response given by the recipient to a question posed, and a sixth information identifying a web site from which the web page is requested;
preparing a profile for the recipient in real-time using at least one of the first information, the second information, the third information, the fourth information, the fifth information, and the sixth information;
selecting from a plurality of advertisements at least one said advertisement having a correlation with the profile of the recipient; and sending the selected advertisement to the recipient over the Internet.

37. A method according to claim 36, wherein the step of sending comprises transmitting the advertisement along with the requested web page so that the advertisement is displayed together with the web page.

38. A system that determines a price for an Internet advertisement sent from a web host computer to a recipient who is using the Internet, comprising:
a timer that measures a view time of how long the recipient viewed the advertisement;
an analyzer that conducts an inquiry check by determining whether the recipient sent the advertiser an inquiry after receiving the advertisement and conducts an order check by determining whether the recipient has at least begun to place an order with the advertiser after receiving the advertisement; and
a price selector which uses at least one of the view time, the inquiry check and the order check to select the price for the advertisement.

39. A system according to claim 38, wherein the analyzer concludes a multiple inquiry check by determining whether the recipient sent the advertiser multiple inquiries drawn to at least two different offers by the advertiser and a multiple order check to determine whether the recipient has at least begun to place more than one order with the advertiser after receiving the advertisement, and the price selector uses at least one of the multiple inquiry check and the multiple order check to select the price for the advertisement.

40. A pricing method for determining a price for an Internet advertisement sent from a web host computer to a recipient who is using the Internet, comprising the steps of:
measuring how long the recipient viewed the advertisement to obtain a view time;
determining whether the recipient sent the advertiser an inquiry after receiving the advertisement to obtain an inquiry check;
determining whether the recipient has at least begun to place an order with the advertiser after receiving the advertisement to obtain an order check; and
selecting the price for the advertisement according to at least one of the view time, the inquiry check and the order check.

41. A pricing method according to claim 40, further comprising the steps of:
determining whether the recipient sent the advertiser multiple inquiries drawn to at least two different offers by the advertiser to obtain a multiple inquiry check;
determining whether the recipient has at least begun to place more than one order with the advertiser after receiving the advertisement to obtain a multiple order check;
selecting the price for the advertisement according to at least one of the multiple inquiry check and the multiple order check.
